(19) United States
(12) Patent Application Publication
(10) Pub. No.: US 2002/0006377 A1
(43) Pub. Date: Jan. 17, 2002

(54) Reformer having a dynamically adaptable reaction surface

(76) Inventors: Arno Castner, Ruckersdorf (DE); Roland Kircher, Aurachtal (DE)

Correspondence Address: LERNER AND GREENBERG, P.A., Post Office Box 2480, Hollywood, FL, 33022-2480, US

(21) Appl. No.: 09/845,411

(22) Filed: Apr. 30, 2001

Related U.S. Application Data
(63) Continuation of application No. PCT/DE99/03460, filed on Oct. 27, 1999.

(30) Foreign Application Priority Data
Oct. 30, 1998 (DE) 198 50 178.1

(51) Int. Cl. C01B 3/26

(52) U.S. Cl. 423/651; 423/659

(57) ABSTRACT

A reformer for reforming methanol and/or natural gas, in particular one for producing hydrogen for fuel cell systems. The reformer has a reformer chamber having a dynamically adaptable reaction surface such that, depending on need, the reaction surface can be varied such that the reformer does not fall below a prescribed partial load.

### BACKGROUND OF THE INVENTION

### 1. Field of the Invention

The invention relates to a reformer for reforming methanol and/or natural gas, in particular one for producing hydrogen for fuel cell systems of stationary and of mobile application.

Known to date are large-scale industrial plants that have an efficiency of approximately 80% when operating at full load. Their efficiency drops dramatically in the region below 70% operating at partial load. In the case of dynamic operation of fuel cell systems, the known reformers drop below the 70% partial load limit so frequently that it is necessary to look for solutions so that the reformer efficiency does not have a negative effect on the overall energy-converting system.

### SUMMARY OF THE INVENTION

It is accordingly an object of the invention to provide a reformer having a dynamically adaptable reaction surface which overcome the above-mentioned disadvantages of the prior art devices and methods of this general type, which has a high efficiency as far as into the extreme partial load region. Such a reformer can be used both for stationary and for mobile applications.

With the foregoing and other objects in view there is provided, in accordance with the invention, a reformer for reforming a gas including natural gas and methanol gas. The reformer contains a carrier, a catalyst disposed on the carrier, a heater, a reformer chamber having a dynamically adaptable reaction surface, at least one gas inlet connected to the reformer chamber, and at least one gas outlet connected to the reformer chamber.

The object is achieved by virtue of the fact that the reformer has a modular configuration, and thus a dynamically adaptable reaction surface of the reformer chamber, is created, such that even given a de facto small gas volume (to be reformed), the reformer chamber can be reduced to so small a surface that the reformer operates with a high partial load and thus high efficiency.

The invention relates to a reformer for reforming natural gas and/or methanol, containing a catalyst on a carrier, a heater, at least one gas inlet and one gas outlet and the reformer chamber, the reformer chamber having a dynamically adaptable reaction surface.

The invention also relates to a method for operating a reformer, in which the gas volumetric flow and/or the gas pressure of the incoming gas has a direct influence on the reaction surface of the reformer chamber used, and thus the reaction surface can be adapted to the current requirement and falling below a prescribed partial load of the reformer does not occur.

According to a preferred refinement of the invention, the reformer chamber is subdivided into a plurality of subchambers which are gradually filled with gas in conjunction with an increasing load and therefore increasing gas volumetric flow, and rendered ready for operation.

The reformer chamber preferably has a cylindrical configuration in the case of which the subchambers are disposed concentrically about the guide rod, located on the central axis, for the gas inlet. Any subdividable reaction space in the reformer is denoted as a reformer chamber, in particular it is also possible here for a honeycomb structure to be involved.

The reaction surface of the reformer chamber can preferably be adjusted in defined steps, if an additional subchamber in the reformer is respectively opened as the load increases. The reaction surface of the reformer chamber can, however, also be continuously variable if, for example, the circumference of the cylinder can be adjusted within appropriate limits (in the manner of hose clamps).

In accordance with an added feature of the invention, a nozzle is connected to the gas inlet and the dynamically adaptable reaction surface is automatically adjustable via a dynamic pressure produced by the nozzle.

In accordance with a mode of the invention, there is the step of using the gas volumetric flow of the incoming gas in the gas inlet of the reformer chamber, in conjunction with a piston structure, to open additional reformer subchambers of the reformer chamber.

Other features which are considered as characteristic for the invention are set forth in the appended claims.

Although the invention is illustrated and described herein as embodied in a reformer having a dynamically adaptable reaction surface, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

FIG. 1 is a diagrammatic, longitudinal sectional view through a reformer chamber;

FIG. 2, 2a and 2b are cross-sectional views through the reformer chamber; and

FIG. 3 is a longitudinal sectional view through the reformer chamber.

### DESCRIPTION OF THE PREFERRED EMBODIMENTS

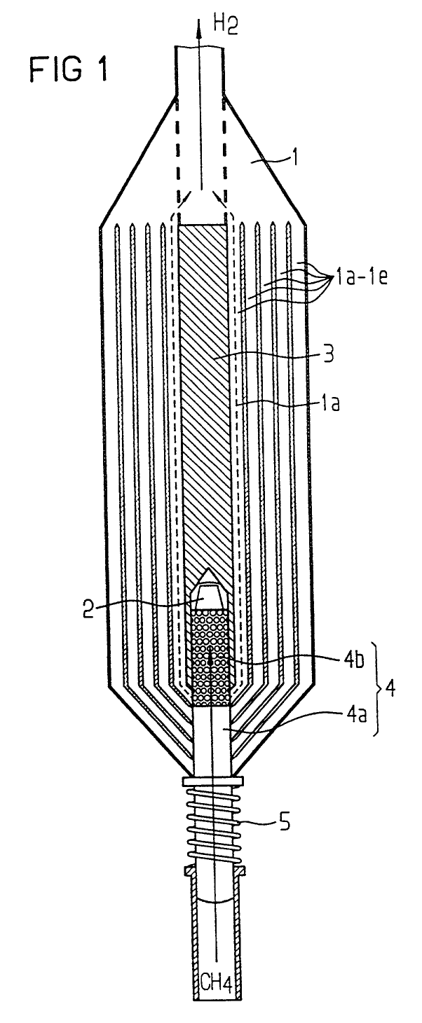

In all the figures of the drawing, sub-features and integral parts that correspond to one another bear the same reference symbol in each case. Referring now to the figures of the drawing in detail and first, particularly, to FIG. 1 thereof, there is shown a reformer chamber 1 with five subchambers 1a, 1b, 1c, 1d and 1e. A gas (for example methane) enters the reformer chamber 1 from below via a gas feed pipe 4 disposed in a centrally disposed gas-guiding rod 3. The gas feed pipe 4 can be displaced and has an impermeable lower part 4a, a perforated, upper part 4b and, at an uppermost end, a nozzle 2. A dynamic pressure that presses the gas feed pipe 4 against a return spring 5 is produced by the nozzle 2 at the upper end in the gas-guiding rod 3. In FIG. 1, the dynamic pressure suffices for the perforated part 4b of the gas feed pipe 4 to reach over the opening of the first subchamber 1a. Thus, gas which must be reformed flows only into the reformer chamber 1a, and hydrogen escapes at the top from the reformer chamber 1a. The reformer chambers 1b, 1c, 1d and 1e are sealed by the lower, impermeable part 4a of the gas feed pipe 4. The gas pressure inside the reformer chamber 1 is therefore high because of the restricted volume and the thereby limited reaction surface, although the reformer is actually only operated with an extreme partial load.

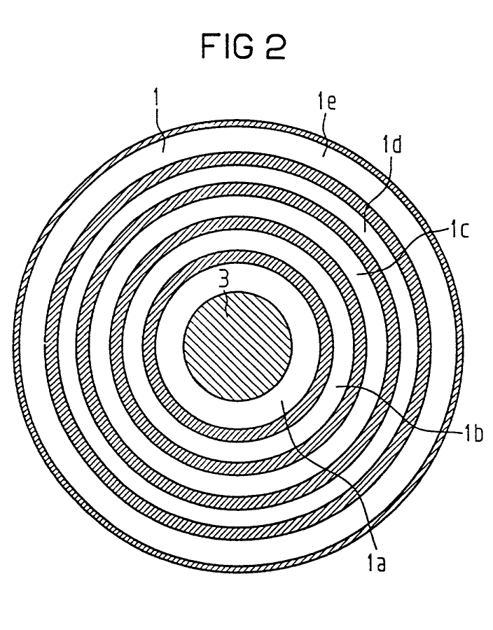

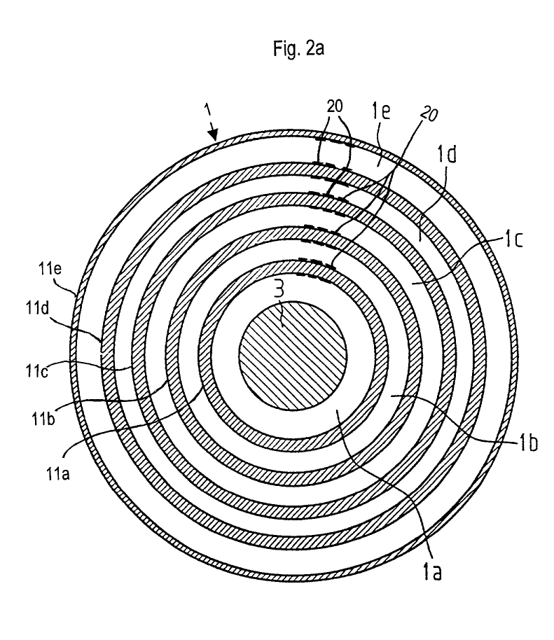

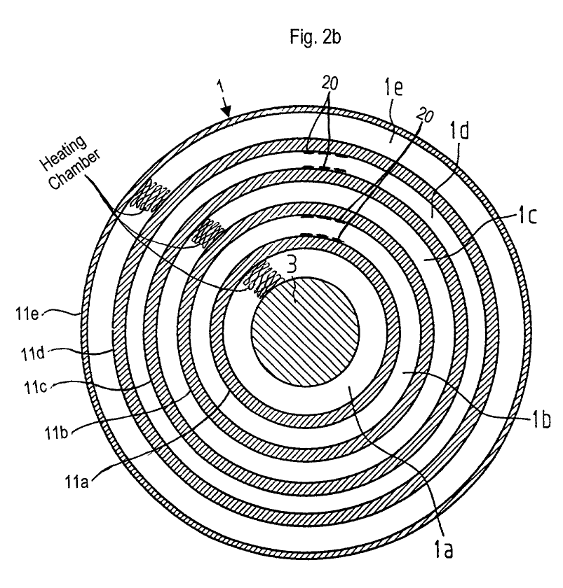

FIG. 2 shows from above the configuration of the subchambers 1a to 1e (with an increasing reaction surface and rising volume of the reformer chamber used) in the reformer chamber 1. The gas-guiding rod 3 is situated in the middle.

It can be seen from FIGS. 2a and 2b that the individual subchambers 1a to 1e of the reformer 1 are separated by concentric ring walls 11a to 11e. The surfaces of the walls 11a to 11e are carriers for a respective amount of a catalyst material 20.

In FIG. 2a it is possible to entail (cause) an exothermal reaction by a sub-stoichiometric addition of oxygen to the reformer gas in the individual reformer subchambers 1a to 1e so that heat necessary for reforming of CH₄ is produced “in situ,”. Chemically, a partial oxidation occurs corresponding to

CH₄+O₂=CO₂+H₂

while releasing hydrogen, with carbon dioxide as a secondary product (by-product).

Alternatively, each second concentric chamber may be used for the combustion of the reformer gas for the purpose of heat generation thereby forming a heater for the other subchambers. In addition to the heat necessary for the endothermal reaction of a so-called steam or vapor reforming, a reaction occurs corresponding to

CH₄+2H₂O+CO₂₌4 H₂

for releasing hydrogen, with carbon-dioxide as a by-product.

In FIG. 2b, two chambers act as a heater respectively for the ring-shaped chamber disposed therebetween, for example the subchambers 1a and 1c act as the heater for the reformer subchamber 1b and the subchambers 1c and 1e act as a heater for the reformer subchamber 1d. This applies correspondingly for further subchambers not illustrated in detail in FIG. 2b.

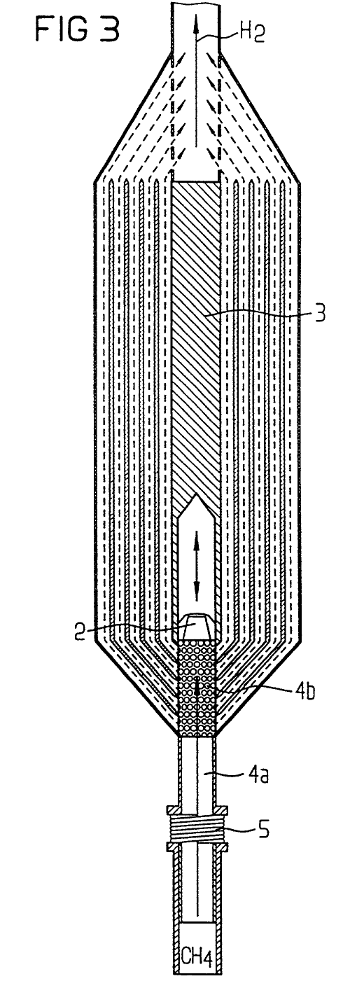

The same view as in FIG. 1 is shown again in FIG. 3, but here the dynamic pressure suffices for all subchambers of the reformer chamber (1a to 1e) to have gas supplied to flow in them via the perforated upper part 4b of the gas feed pipe 4.

The return spring 5 at the lower end of the gas feed pipe 4 is completely compressed. The reformer proceeds to full load, and hydrogen flows out of the top from all of the subchambers 1a to 1e.

The problem of the drop in efficiency in the partial load operation of reformers of fuel cell systems is solved for the first time with the invention. The invention proposes a dynamically adaptable or multistage concept for a natural gas and/or methanol reformer. In the lowermost partial load operation, the reformer is operated with the smallest possible reaction surface.

Further stages are switched in depending on the load state and hydrogen requirement of the fuel cell system. Reforming is therefore carried out at an optimized efficiency, because owing to the dynamically adaptable reaction surface, falling below a prescribed partial load of, for example, 60%, 70% or 80% does not occur.

The present invention optimizes the efficiency of the reformer by a dynamically adaptable reaction surface of the reformer chamber 1. The extra structural outlay for the multistage embodiment, for example, is limited to a few cost-effective materials, such as steel for the partitions of the reformer subchambers 1a-e and the gas inlets. The outlay on expensive materials, such as catalyst, remains the same by comparison with the known systems.

We claim:

1. A reformer for reforming a gas including natural gas and methanol gas, comprising:
a carrier;
a catalyst disposed on said carrier;
heating means;
a reformer chamber having a dynamically adaptable reaction surface;
at least one gas inlet connected to said reformer chamber; and
at least one gas outlet connected to said reformer chamber.

2. The reformer according to claim 1, wherein said dynamically adaptable reaction surface is dynamically adaptable in defined steps.

3. The reformer according to claim 1, including a nozzle connected to said gas inlet and said dynamically adaptable reaction surface is automatically adjustable via a dynamically pressure produced by said nozzle.

4. A method for operating a reformer, which comprises the step of:
adapting a reaction surface of a reformer chamber to a gas volumetric flow of an incoming gas, the gas volumetric flow of the incoming gas having a direct influence on a size of the reaction surface of the reformer chamber, and falling below a prescribed partial load of the reformer cannot occur.

5. The method according to claim 4, which comprises using the gas volumetric flow of the incoming gas in the gas inlet of the reformer chamber, in conjunction with a piston structure, to open additional reformer subchambers of the reformer chamber.

6. A reformer for reforming a gas including natural gas and methanol gas, comprising:
a reformer chamber having a dynamically adaptable reaction surface;
at least one gas inlet connected to said reformer chamber; and
at least one gas outlet connected to said reformer chamber.

7. The reformer according to claim 6, wherein said dynamically adaptable reaction surface is dynamically adaptable in defined steps.

8. The reformer according to claim 6, including a nozzle connected to said gas inlet and said dynamically adaptable reaction surface is automatically adjustable via a dynamic pressure produced by said nozzle.

9. A reformer for reforming a gas including natural gas and methanol gas, comprising:
a carrier having carrier walls defining a reformer chamber with a dynamically adaptable reaction surface and subchambers;
a catalyst disposed on said carrier walls;
at least one gas inlet connected to said carrier and communicating with said reformer chamber; and
at least one gas outlet connected said carrier and communicating with said reformer chamber.

10. The reformer according to claim 9, wherein said dynamically adaptable reaction surface is dynamically adaptable in defined steps.

11. The reformer according to claim 9, including a nozzle connected to said gas inlet and said dynamically adaptable reaction surface is automatically adjustable via a dynamic pressure produced by said nozzle.

12. The reformer according to claim 9, wherein at least one of said subchambers functions as a heater for heating another of said subchambers.
